(19) United States
(12) Patent Application Publication
(10) Pub. No.: US 2015/0348445 A1
(43) Pub. Date: Dec. 3, 2015

(54) NAME CARD STRUCTURE COMBINED WITH MIRROR SURFACE

(71) Applicant: CHIN-YEH CO., LTD., Taipei City (TW)

(72) Inventor: Ein-Yiao SHEN, Taipei City (TW)

(73) Assignee: CHIN-YEH CO., LTD., Taipei City (TW)

(21) Appl. No.: 14/289,371

(22) Filed: May 28, 2014

(51) Int. Cl. G09F 3/02; G02B 1/04; G02B 5/08

(52) U.S. Cl. CPC G09F 3/02; G02B 5/0808; G02B 1/04; G09F 2003/0257; G09F 2003/0279

(57) ABSTRACT

A name card structure combined with a mirror surface is disclosed. One of the surfaces of the name card structure serves as a name card including texts and patterns, the other one serves as the mirror surface. The mirror surface includes at least a light-reflecting material layer and a soft transparent material layer, thus may be used as a mirror for reflecting external images. The contents of texts, patterns, or combinations of both texts and patterns may be printed on one of the surfaces of the name card structure. Alternatively, a name card body may be directly combined with one of the surfaces of the light-reflecting material layer, while the soft transparent material layer is disposed on the other surface of the light-reflecting material layer. The soft transparent material layer is transparent and extendable, and the light-reflecting material layer may reflect the external images on the soft transparent material layer.

### BACKGROUND OF THE DISCLOSURE

1. Field of the Disclosure

The present disclosure relates to a name card structure combined with a mirror surface; in particular, to a name card structure capable of serving as a mirror for reflecting external images.

2. Description of Related Art

The name card and the mirror are commonly used items in daily life of the modern people, and are carried and used thereby. The staffs of the stores or the companies especially the sales people utilize the name cards to marketing and promotional purposes. For properly managing the name cards upon a large volume of the like have been received, one conventional approach is to put them into the name card cases. However, it is quite inconvenient for those name cards to be properly arranged and categorized. In addition, the information printed on the name card usually includes name, title, company name, service, phone number, or e-mail address, etc.

The hardness of the presently used mirror is larger than the hardness of average items though the thickness of it renders inconvenient carrying around the mirror.

Therefore, if the name card can be combined with a soft mirror, which is of the characteristics of being the light, bendable, shatterproof, more convenient to be carried around, and heat resistant, such name card could be of more functionality and gaining some popularity.

### SUMMARY OF THE DISCLOSURE

The present disclosure shows a name card structure combined with a mirror surface. The name card structure has the features including lightness, bendable capability, shatterproof capability, and heat resistance, and is more convenient to be carried around and used.

The aforementioned name card structure combined with the mirror surface includes a light-reflecting material layer and a soft transparent material layer. The light-reflecting material layer includes two surfaces, and one of the two surfaces is used as a name card which contains a text, a pattern, or a combination of both the text and the pattern. The soft transparent material layer is disposed at the other surface of the light-reflecting material layer, and is transparent and extendable. The light-reflecting material layer may be able to reflect external images on the soft transparent material layer.

Specifically, the light-reflecting material layer is a silver-plated layer, for forming a silver mirror between the soft transparent material layer and a base paper.

Specifically, the light-reflecting material layer is a copper-plated layer, for forming a copper mirror between the soft transparent material layer and the base paper.

Specifically, the light-reflecting material layer is an alloy-plated layer, for forming an alloy mirror between the soft transparent material layer and the base paper.

Specifically, the light-reflecting material layer is a chemical fusion-plated layer, for forming a chemical fusion mirror between the soft transparent material layer and the base paper.

Specifically, the light-reflecting material layer is a metal fusion-plated layer, for forming a metal fusion mirror between the soft transparent material layer and the base paper.

Specifically, the soft transparent material layer is a transparent film or a soft plastic.

Specifically, the soft plastic is made from a polyethylene terephthalate (PET).

Specifically, the soft plastic is made from a polyvinyl chloride (PVC).

Specifically, the soft plastic is made from a polyimide (PI).

Specifically, the soft plastic is made from a polypropylene (PP).

Specifically, the contents of the texts, the patterns, or the combination of both the texts and the patterns may be printed on one of the surfaces of the light-reflecting material layer of the name card structure combined with the mirror surface.

In addition, the present disclosure also shows another name card structure combined with a mirror surface. The name card structure includes a name card body and an image reflecting layer. The name card body includes two surfaces, and one of the two surfaces is used as a name card including a text, a pattern, or a combination of both the text and the pattern. The image reflecting layer is adhered on the other surface of the name card body. One surface of the image reflecting layer includes a light-reflecting material layer and a soft transparent material layer. The light-reflecting material layer is a plate-able dressing which is able to reflect lights. One surface of the light-reflecting material layer is combined with the other surface of the name card body, and the soft transparent material layer is disposed on the other surface of the light-reflecting material layer. The soft transparent material layer is transparent and extensible. Moreover, the light-reflecting material layer is able to reflect the external images on the soft transparent material layer.

Specifically, the other surface of the image reflecting layer facing to the name card body includes an adhesive material for attaching the image reflecting layer to the name card body.

Specifically, the light-reflecting material layer is a silver-plated layer, for forming a silver mirror between the soft transparent material layer and a base paper.

Specifically, the light-reflecting material layer is a copper-plated layer, for forming a copper mirror between the soft transparent material layer and the base paper.

Specifically, the light-reflecting material layer is an alloy-plated layer, for forming an alloy mirror between the soft transparent material layer and the base paper.

Specifically, the light-reflecting material layer is a chemical fusion-plated layer, for forming a chemical fusion mirror between the soft transparent material layer and the base paper.

Specifically, the light-reflecting material layer is a metal fusion-plated layer, for forming a metal fusion mirror between the soft transparent material layer and the base paper.

Specifically, the soft transparent material layer is a transparent film or a soft plastic.

Specifically, the soft plastic is made from a polyethylene terephthalate (PET).

Specifically, the soft plastic is made from a polyvinyl chloride (PVC).

Specifically, the soft plastic is made from a polyimide (PI).

Specifically, the soft plastic is made from a polypropylene (PP).

Specifically, the contents of the texts, the patterns, or the combination of both the texts and the patterns may be printed on one of the surfaces of the name card body.

Specifically, the paper type of the name card body may be a linen paper, a canvas paper, a coated post paper, a wove paper, a denim paper, a crystal diamond paper, a star dream paper, a glare paper, a royal grain paper, a fine wave paper, a yong-cai paper, a willow paper, a jazz paper, a wove card, a superior card, a superior wove card, a five-color first-level card, a Sweden first-level card, or a silver foil card.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a cross-section schematic diagram of a name card structure combined with a mirror surface according to the first embodiment of the present disclosure;

FIG. 2A shows a schematic diagram of one surface of the name card structure combined with the mirror surface according to the first embodiment of the present disclosure;

FIG. 2B shows a schematic diagram of the other surface of the name card structure combined with the mirror surface according to the first embodiment of the present disclosure;

FIG. 3 shows a cross-section schematic diagram of a name card structure combined with a mirror surface according to a second embodiment of the present disclosure;

FIG. 4A shows a schematic diagram of one surface of the name card structure combined with the mirror surface according to the second embodiment of the present disclosure; and

FIG. 4B shows a schematic diagram of the other surface of the name card structure combined with the mirror surface according to the second embodiment of the present disclosure.

### DETAILED DESCRIPTION OF THE PREFERRED EMBODIMENTS

The aforementioned and other technical contents, features, and efficacies can be clearly shown by the following detail descriptions of preferred embodiments along with figures.

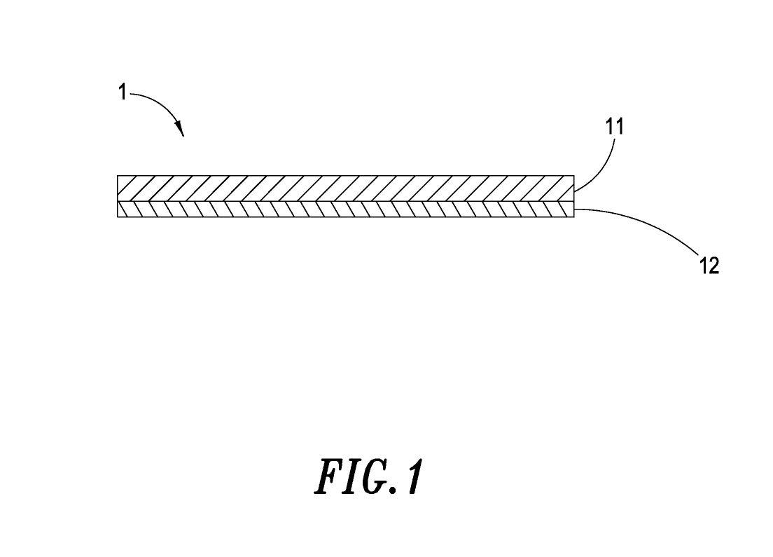

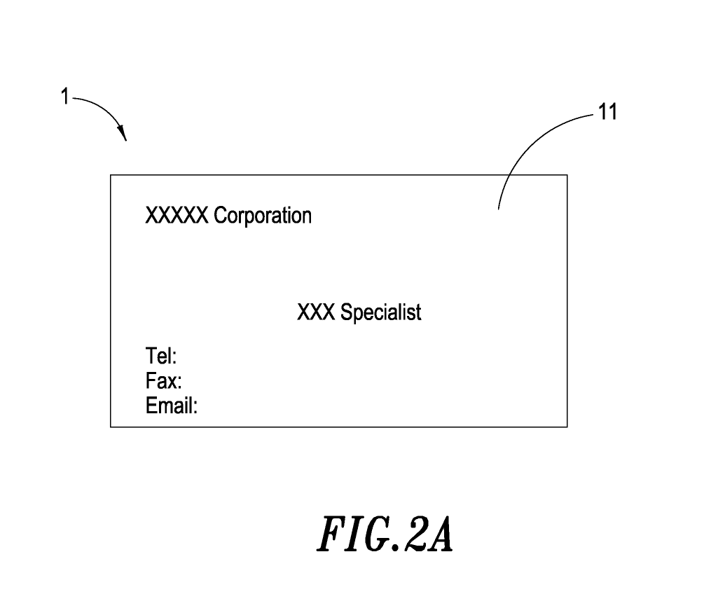

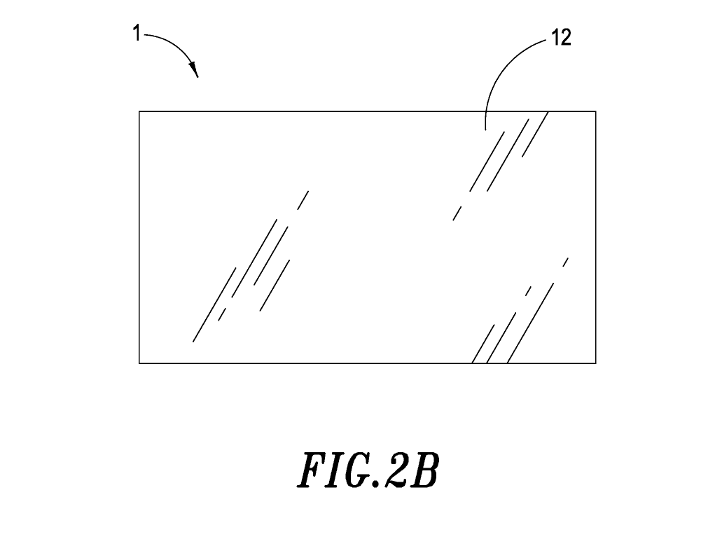

Please refer to FIG. 1, and FIG. 2A, and FIG. 2B which are a cross-section schematic diagram of a name card structure 1 combined with a mirror surface according to the first embodiment of the present disclosure and the schematic diagrams of the surfaces of the name card structure according to the first embodiment, respectively. The name card structure 1 combined with the mirror surface includes a light-reflecting material layer 11 and a soft transparent material layer 12. The light-reflecting material layer 11 includes two surfaces, as shown in FIG. 2A. The contents of the texts, the patterns, or the combination of both the texts and the patterns may be printed on one of the two surfaces of the light-reflecting material layer 11, and the contents may generally include a company name, an address, a phone number, a fax number, or contents of advertisement and promotional information.

The light-reflecting material layer 11 is a plate-able dressing which is able to reflect lights. For example, if the light-reflecting material layer 11 is a silver-plated layer, a copper-plated layer, an alloy-plated layer, a chemical fusion-plated layer, or a metal fusion-plated layer, a silver mirror, a copper mirror, an alloy mirror, a chemical fusion mirror, or a metal fusion mirror may be respectively formed as the result.

The soft transparent material layer 12 is disposed on the other surface of the light-reflecting material layer 11. The soft transparent material layer 12 is transparent and extendable, and the light-reflecting material layer 11 is able to reflect the external images on the soft transparent material layer 12. When the light passes through the soft transparent material layer 12 and reaches the light-reflecting material layer 11, as shown in FIG. 2B, the images may be reflected to the soft transparent material layer 12 because of the light-reflecting material layer 11. Therefore, the soft transparent material layer 12 may serve as a mirror for reflecting external images.

The soft transparent material layer 12 may be made from a transparent film, a tear resistant paper, a cloth, or a soft plastic which is implemented in terms of soft and transparent material. Therefore, the name card structure 1 combined with the mirror surface may be bendable, shatterproof, and thin/compact, and easy to be carried around. Thus, in addition to presenting the information, the name card structure 1 may also function as a mirror.

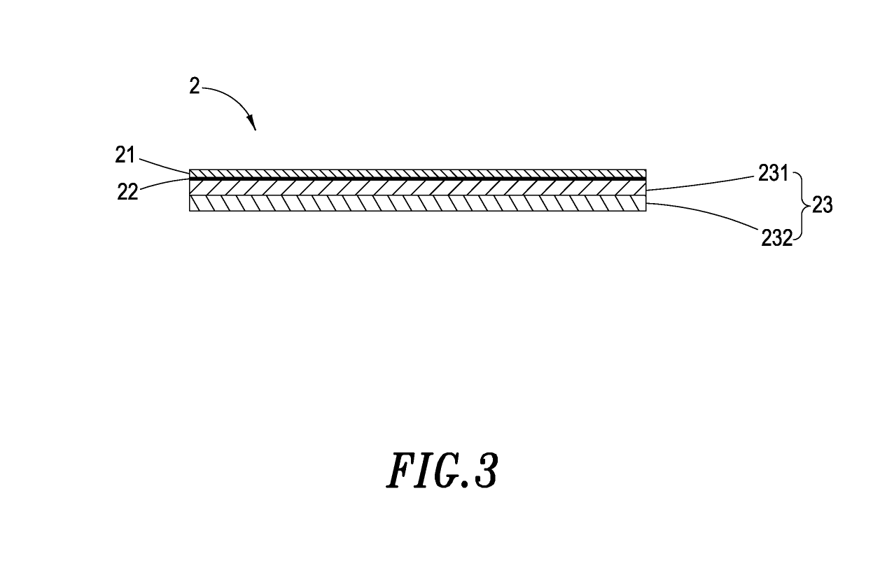

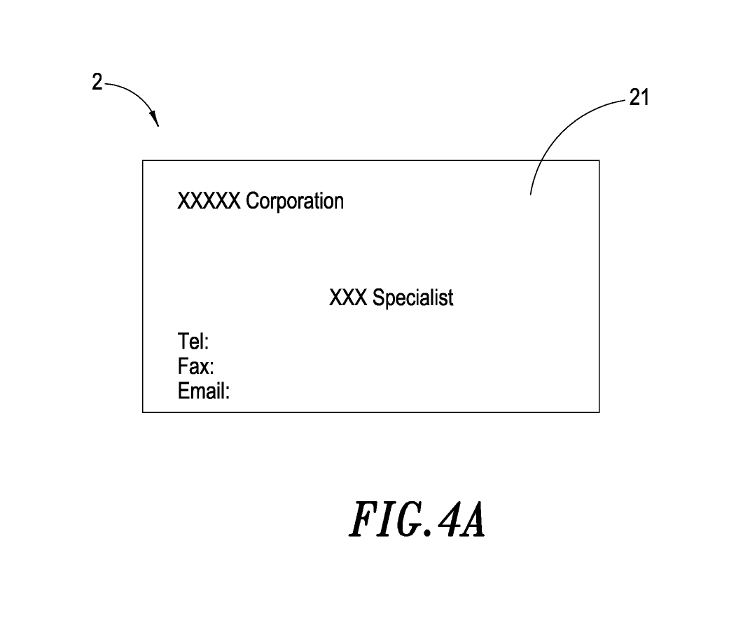

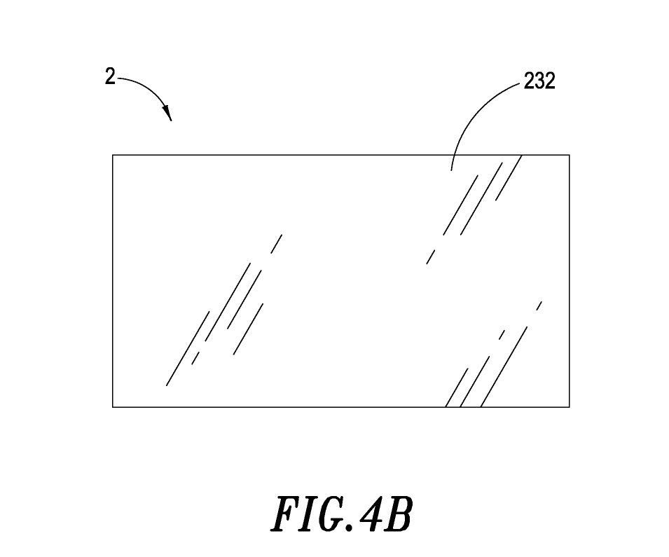

Due to the different material used for the soft transparent material layer 12, the contents of the texts, the patterns, or the combination of both the texts and the patterns printed on one of the two surfaces of the light-reflecting material layer 11 may not be optimal. Therefore, the present disclosure shows as shown in FIG. 3 another name card structure 2 combined with a mirror surface. The name card structure 2 may combine a name card body 21 on an image reflecting layer 23 including a light-reflecting material layer 231 and a soft transparent material layer 232. The name card body 21 includes two surfaces, as shown in FIG. 4A, with the contents of the texts, the patterns, or the combination of the texts and the patterns printed on one surface of the name card body 21. The features of the light-reflecting material layer 231 and the soft transparent material layer 232 of the image reflecting layer 23 are similar to their counterparts in the aforementioned first embodiment, thus are not further described.

The light-reflecting material layer 231 includes two surfaces, and one of the two surfaces includes an adhesive material 22 for attaching the image reflecting layer 23 to the name card body 21. The soft transparent material layer 232 is disposed on the other surface of the light-reflecting material layer 231. The soft transparent material layer 232 is transparent and extendable, thus the light-reflecting material layer 231 is able to reflect the external images on the soft transparent material layer 232, as shown in FIG. 4B, and functions as a mirror.

In addition, the paper type of the name card body 21 may be a linen paper, a canvas paper, a coated post paper, a wove paper, a denim paper, a crystal diamond paper, a star dream paper, a glare paper, a royal grain paper, a fine wave paper, a yong-cai paper, a willow paper, a jazz paper, a wove card, a superior card, a superior wove card, a five-color first-level card, a Sweden first-level card, or a silver foil card.

The advantages of the name card structure combined with a mirror surface provided by the present disclosure are as follows:

1. The present disclosure combines the name card with the soft mirror, thus may be thin, bendable, shatterproof, and heat resistant in addition to the functionalities of the name card. Therefore, the name card structure is convenient for being carried around and of at least dual functionality.

2. That the present disclosure uses the soft mirror could add more value to the traditional name card structure.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A name card structure combined with a mirror surface, comprising:
a light-reflecting material layer, including two surfaces, wherein one of the two surfaces is used as a name card structure which includes a text, a pattern, or a combination of both the text and the pattern; and
a soft transparent material layer, disposed on the other surface of the light-reflecting material layer, wherein the soft transparent material layer is transparent and extendable, and the light-reflecting material layer reflects an external image on the soft transparent material layer.

2. The name card structure combined with the mirror surface according to claim 1, wherein the light-reflecting material layer is a silver-plated layer, for forming a silver mirror between the soft transparent material layer and a base paper.

3. The name card structure combined with the mirror surface according to claim 1, wherein the light-reflecting material layer is a copper-plated layer, for forming a copper mirror between the soft transparent material layer and a base paper.

4. The name card structure combined with the mirror surface according to claim 1, wherein the light-reflecting material layer is an alloy-plated layer, for forming an alloy mirror between the soft transparent material layer and a base paper.

5. The name card structure combined with the mirror surface according to claim 1, wherein the light-reflecting material layer is a chemical fusion-plated layer, for forming a chemical fusion mirror between the soft transparent material layer and a base paper.

6. The name card structure combined with the mirror surface according to claim 1, wherein the light-reflecting material layer is a metal fusion-plated layer, for forming a metal fusion mirror between the soft transparent material layer and a base paper.

7. The name card structure combined with the mirror surface according to claim 1, wherein the soft transparent material layer is a transparent film or a soft plastic.

8. The name card structure combined with the mirror surface according to claim 7, wherein the soft plastic is made from a polyethylene terephthalate (PET).

9. The name card structure combined with the mirror surface according to claim 7, wherein the soft plastic is made from a polyvinyl chloride (PVC).

10. The name card structure combined with the mirror surface according to claim 7, wherein the soft plastic is made from a polyimide (PI).

11. The name card structure combined with the mirror surface according to claim 7, wherein the soft plastic is made from a polypropylene (PP).

12. The name card structure combined with the mirror surface according to claim 1, wherein a content of the text, the pattern, or the combination of both the text and the pattern is printed on one of the two surfaces of the light-reflecting material layer.

13. A name card structure combined with a mirror surface, comprising:
a name card body, including two surfaces, wherein one of the two surfaces is used as a name card structure including a text, a pattern, or a combination of both the text and the pattern;
an image reflecting layer, adhered to the other surface of the name card body, wherein a surface of the image reflecting layer includes a light-reflecting material layer and a soft transparent material layer, the light-reflecting material layer is a plate-able dressing capable of reflecting light, one surface of the light-reflecting material layer is combined with the other surface of the name card body, the soft transparent material layer is disposed on the other surface of the light-reflecting material layer, the soft transparent material layer is transparent and extendable, and the light-reflecting material layer is for reflecting an external image on the soft transparent material layer.

14. The name card structure combined with the mirror surface according to claim 13, wherein a surface of the image reflecting layer facing to the other surface of the name card body includes an adhesive material, for attaching the image reflecting layer to the name card body.

15. The name card structure combined with the mirror surface according to claim 13, wherein the light-reflecting material layer is a silver-plated layer, for forming a silver mirror between the soft transparent and a base paper.

16. The name card structure combined with the mirror surface according to claim 13, wherein the light-reflecting material layer is a copper-plated layer, for forming a copper mirror between the soft transparent and a base paper.

17. The name card structure combined with the mirror surface according to claim 13, wherein the light-reflecting material layer is an alloy-plated layer, for forming an alloy mirror between the soft transparent and a base paper.

18. The name card structure combined with the mirror surface according to claim 13, wherein the light-reflecting material layer is a chemical fusion-plated layer, for forming a chemical fusion mirror between the soft transparent and a base paper.

19. The name card structure combined with the mirror surface according to claim 13, wherein the light-reflecting material layer is a metal fusion-plated layer, for forming a metal fusion mirror between the soft transparent and a base paper.

20. The name card structure combined with the mirror surface according to claim 13, wherein the soft transparent material layer is a transparent film or a soft plastic.

21. The name card structure combined with the mirror surface according to claim 20, wherein the soft plastic is made from a polyethylene terephthalate (PET).

22. The name card structure combined with the mirror surface according to claim 20, wherein the soft plastic is made from a polyvinyl chloride (PVC).

23. The name card structure combined with the mirror surface according to claim 20, wherein the soft plastic is made from a polyimide (PI).

24. The name card structure combined with the mirror surface according to claim 20, wherein the soft plastic is made from a polypropylene (PP).

25. The name card structure combined with the mirror surface according to claim 13, wherein a content of the text, the pattern, or the combination of both the text and the pattern is printed on one of the two surfaces of the name card body.

26. The name card structure combined with the mirror surface according to claim 13, wherein a paper type of the name card body is a linen paper, a canvas paper, a coated post paper, a wove paper, a denim paper, a crystal diamond paper, a star dream paper, a glare paper, a royal grain paper, a fine wave paper, a yong-cai paper, a willow paper, a jazz paper, a wove card, a superior card, a superior wove card, a five-color first-level card, a Sweden first-level card, or a silver foil card.
